(19) United States
(12) Patent Application Publication
(10) Pub. No.: US 2008/0263589 A1
(43) Pub. Date: Oct. 23, 2008

(54) System and method using web database and video caching and streaming programming for video classified advertisements

(76) Inventors: Alan Jacobson, Norfolk, VA (US); Janet DeGeorge, Gilbert, AZ (US); John C. Small, Knoxville, TN (US)

Correspondence Address: GUERRY LEONARD GRUNE, 784 S VILLIER CT., VIRGINIA BEACH, VA, 23452, US

(21) Appl. No.: 11/789,016

(22) Filed: Apr. 23, 2007

(51) Int. Cl. H04N 7/173

(52) U.S. Cl. 725/37

(57) ABSTRACT

The present application discloses a video classified advertisement web-enabled operation combining advertisements with videos specifically designed to advertise items and services for sale. The website, www.RealPeopleRealStuff.com, combines the methodology of Drupal modules, but not limited to Drupal open source modules, creates a content data model for video ads using such as Drupal's CCK module, converts most video formats, MPEG, QuickTime, and AVI, into flash (FLV) format using such as Drupal's FFMPEG module or maintain native video format if not convertible to flash format (FLV), creates a software routine that determines the most cost effective way to download videos, moves the video storage from the hosting servers to the Simple Storage Server (S3) such as Amazon S3 servers, creates an Application programming interface (API) between the hosting and storage servers, and simultaneously or later creates a category taxonomy for grouping ads for a video classified advertisement website. This present application presents a programming system that allows the seller to showcase the attributes of their product or service through video advertisements in a way that text and still photos cannot. This system provides sellers or businesses the ability to star in their own commercials appealing to their desire for celebrity. This application provides businesses a method to advertise via videos. This application's web interface allows users to post their video advertisements under uniquely named categories, which encourages users to be creative with their video ads. The present application allows users to schedule their frequency, track the effectiveness of their campaign(s), and pay for their advertisements without the assistance of a sales rep. Performing all these functions online, 24/7, is another distinct advantage over any known web-enabled service.

### BACKGROUND OF THE INVENTION

The present application includes an invention that provides a video classified advertisement website combining advertisements with videos specifically designed to advertise items for sale, services for sale, real estate and employment. There already exists websites (www.craigslist.com, www.ebay.com, www.monster.com, www.careerbuilder.com) that advertise with text and graphics but do not use videos and there are also websites (www.YouTube.com) that use videos for entertainment, but do not advertise items for sale. The present application describes an invention that combines advertisement and video web spaces to create a video classified advertisement website, www.RealPeopleRealStuff.com, or RealPeopleRealStuff. This application hosts video classified advertisements with each item or service for sale. The video ad allows the seller to showcase the attributes of their product or service in a way that text and still photos cannot. For example, a user selling a guitar can demonstrate great sound, or a realtor can show buyers how deep kitchen cabinets or bedroom closets are. This application allows users to post their videos to sell their stuff and/or their services, unlike www.YouTube.com, which provides no financial incentive, but instead provides a vehicle for users to become famous for their catchy video advertisements and make some money at the same time. In the world of Survivor, Amazing Race and American Idol, real people are the new celebrities. RealPeopleRealStuff taps into the public's limitless desire for self-promotion through users' entertaining and humorous video ads to sale a product or service, which reflects the RealPeopleRealStuff's name and slogan, “Star in your own commercial.” In addition, the present application provides for the user a method to receive funds from his/her sold products or services with the potential for notoriety.

The present application's web interface allows users to post their video ads under uniquely named categories, which encourages users to be creative with their video ads. This application allows users to schedule their frequency, track the effectiveness of their campaign(s), and pay for their ads without the assistance of a sales rep. Performing all these functions online, 24/7, is another distinct advantage over most known web-enabled service.

The present application does not hide the product or pricing nor advertise pornographic or inappropriate material. Based on a survey of other task related websites, this application provides a user interface that is graphically simpler, hence easier to use than any other comparable website. The web pages are clearly labeled and consistently designed with the location of the post button, searching by keyword, searching by category or place, suggest new categories, result page, help, login, manage my ads, home, terms of service, privacy policy, FAQs, about us and contact us links appearing in the same area for each web page. The web pages that have forms, for example, “Post”, “Edit”, and “Login”, clearly label all input fields, identifying fields that are optional, and action buttons, such as “SUBMIT” or “LOGIN”. The present application allows the user to indicate a video ad is inappropriate, to edit or remove his/her video ad, and to see clearly the price of the product or service.

This application provides for businesses a method to advertise via videos. Websites like www.Monster.com, www.HotJobs.com and www.CareerBuilder.com have no or virtually no videos. This service will give employers or employees another vehicle to advertise their businesses or employee skills with informative, creative and entertaining video ads. The method can also be applied to the Real Estate and other service industries as well.

The present application includes a revenue model based on selling video advertisements for video advertisement sectors. In addition, this application provides a method for users to earn income from selling his/her products or services.

The present application, www.realpeoplerealstuff.com, integrates modules from the open source software, Drupal and PHP programming libraries. The present application uses Drupal modules but could have chosen other open source software, PHP solely or Perl Scripts with PHP. The Drupal modules include PHP programming libraries, MySQL, CCK, Taxonomy, VideoFlash, FFMPEG and a Unix shell and Ruby/Perl Application Programming Interface (API) between the hosting server and a highly economical Simple Storage Server (S3), such as Amazon S3. Specifically the methodology combines the above Drupal modules, creates a content data model for video ads using a module such as CCK, converts most videos formats, MPEG, QuickTime, and AVI, into the best video format which today is flash (FLV) format using a module such as FFMPEG or if the video is not convertible maintain the native video format, creates a software routine that determines the most cost effective way to download videos, moves the video storage from the hosting servers to a highly economical Simple Storage Server (S3), such as the Amazon S3, creates a Unix shell and Ruby/Perl Application Programming Interface (API) between the hosting and S3 servers, and simultaneously or later creates a category taxonomy for grouping ads for a video classified advertisement website. Presently the cost of bandwidth to play a video on hosting servers is quite expensive for video websites as there is a file download toll per video. This service provides dual site hosting to minimize cost and maximize profit. Resources are hosted in two places: one site warehouses and transmits the resource consuming videos at the lowest possible cost, on a highly economical S3 server, while another site handles the processing of the files, on the hosting server. An analogy is a “barn” where the storage servers reside and the “conveyor” where the file-processing server resides. The concept of reducing the costs of server hosting and/or processing, video storage, or video bandwidth is likely to advance as technology and open source software evolves.

### DESCRIPTION OF PRIOR ART

There are some websites, www.yurth.com, www.cmylist.com, www.cellit.us that attempt to combine the two spaces comprising video and classified advertising. However, most of the advertisements at these sites are text and graphics with no videos or the videos are not advertisements to sell an item but instead provide entertainment. In addition, the products are not easily accessible or categorized, the pricing is hidden or very difficult to find, and the website names do not reflect the merger of the video ad web spaces. Websites like www.craigslist.com, www.ebay.com advertise with text and graphics but with no videos or virtually no videos. Websites like www.Monster.com, www.HotJobs.com and www.CareerBuilder.com advertise employment positions and have no or virtually no videos. YouTube.com uses videos for entertainment and is very clear in their terms of use that warn users not to “post advertisements or solicitations of business”, which teaches away from the business model of the present invention, www.RealPeopleRealStuff.com.

### SUMMARY OF INVENTION

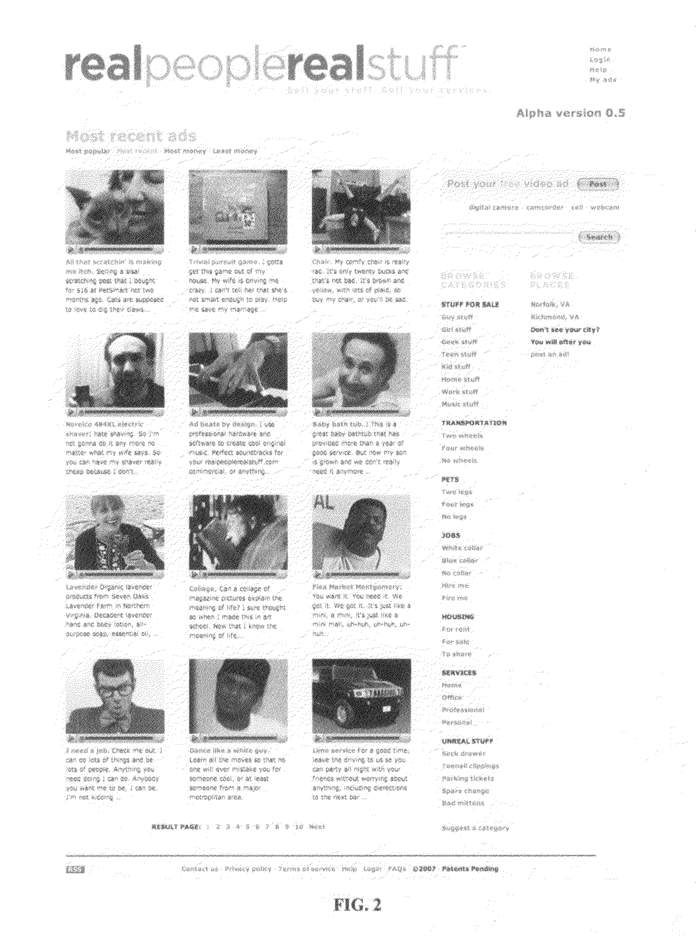

The present application discloses a video classified advertisement web-enabled operation combining advertisements with videos specifically designed to advertise items and services for sale. The present application allows the seller to showcase the attributes of their product or service through video ads in a way that text and still photos cannot. The present application gives sellers or businesses the ability to star in their own commercials. The present application gives businesses a method to advertise via videos. This application's web interface allows users to post their video advertisements under uniquely named categories, which encourages users to be creative with his/her video advertisements (ads). The present application allows users to schedule their frequency, track the effectiveness of their campaign(s), and pay for their ads without the assistance of a sales rep. Performing all these functions online, 24/7, is another distinct advantage over most web-enabled service. The user interface is consistently designed and functionality clearly defined by each web page, which can be seen in FIGS. 2-8. The present application includes a revenue model based on selling video advertisements for video advertisement sectors. In addition, this application provides a method for users to generate revenue from selling his/her products or services.

The website, www.RealPeopleRealStuff.com, combines the methodology of the aforementioned Drupal modules, creates a content data model for video ads using such as the CCK module, converts most video formats, MPEG, QuickTime, and AVI, into the best video format which today is flash (FLV) format, using the FFMPEG module or if the video is not convertible maintain the native video format, creates a software routine that determines the most cost effective way to download videos, moves the video storage from the hosting servers to a highly economical Simple Storage Server (S3), such as the Amazon S3 servers, creates a Unix shell and Ruby/Perl Application Programming Interface (API) between the hosting and highly economical S3 servers, and simultaneously or later creates a category taxonomy for grouping ads for a video classified advertisement website. The concept of reducing the costs of server hosting and/or processing, video storage, or video bandwidth is likely to advance as technology and open source software evolves.

### DETAILED DESCRIPTION OF THE INVENTION

The RealPeopleRealStuff, or RPRS is a video classified advertisement website, combining advertisements with videos specifically designed to advertise items and services for sale. This application allows the seller to showcase the attributes of their product or service through video ads in a way that text and still photos cannot. This application provides for sellers or businesses the ability to star in their own commercials, to appeal to their desire for celebrity. This application provides for businesses a method to advertise via videos. This application's web interface allows users to post their video ads under uniquely named categories, which encourages users to be creative with their video ads. The present application allows users to schedule their frequency, track the effectiveness of their campaign(s), and pay for their ads without the assistance of a sales rep. Performing all these functions online, 24/7, is another distinct advantage over any known web-enabled service. The web pages are clearly labeled and consistently designed with the location of the post button, searching by keyword, searching by category or place, suggest new categories, result page, help, login, manage my ads, home, terms of service, privacy policy, FAQs, about us and contact us links appearing in the same area for each web page. The web pages that have forms, for example, “Post”, “Edit”, and “Login”, clearly label all input fields, identifying fields that are optional, and action buttons, such as “SUBMIT” or “LOGIN”. The present application allows the user to indicate a video ad is inappropriate, to edit or remove his/her video ad, and to see clearly the price of the product or service. This application's user interface is consistently designed and functionality clearly defined by each web page, which can be seen in FIGS. 2-8.

The RealPeopleRealStuff video advertisement content is managed using Drupal and PHP programming libraries. The present application uses Drupal modules but could have chosen other open source software, PHP solely or Perl Scripts with PHP. This application is a system that uses PHP programming language to deliver and cache dynamic content stored in a MySQL relational database. A module, such as the Drupal module CCK, provides the customized content for a video ad. When a user creates a new video ad, the text and references to media objects are formatted in CCK data entry fields, submitted via Web forms, housed in the MySQL and managed by Drupal PHP script libraries.

The RealPeopleRealStuff system assumes users will upload videos in any of several common digital formats, including MPEG, QuickTime, AVI and Flash video (FLV). RPRS serves virtually all videos for public viewing in the Flash (FLV) format, which is generally regarded as most compatible with most browser configurations, and among the highest quality video per bandwidth consumed. This application will use the best video format method, as this technology is likely to advance. It is also possible that automatic uploading will be provided for the user. To provide FLV video in all cases, uploaded video files in other formats must be transcoded to FLV format or an appropriate alternative with a moderate bit rate and frame size.

Users upload source video files to the Web server file system (hosting server), where a cron (timed) process module such as Drupal's FlashVideo, periodically scans for new uploads. When the process finds new videos, it submits them to a server-side transcoding program, such as Drupal's FFMPEG. Since videos come in many formats, such as .dv, .mpeg, .mp4, .avi, .wmv, .flv and some of these formats come in several flavors, such as the H.264 flavor or .mp4, it is virtually impossible to support every format and flavor because they continue to proliferate and evolve. Most of these video formats are converted to Flash (FLV) format by the conversion module such as, FFMPEG and viewed in a web browser with the Flash player. If a video fails to convert to Flash (FLV) format by the conversion module, such as FFMPEG, the video is viewed in its native format using its native player, such as Windows Media Player for .wmv files or Quicktime for .mov files. When the conversion module, FFMPEG converts videos to Flash (FLV) format, it places the newly converted videos in a pre-configured destination into the file system. FFMPEG also generates and stores thumbnail-size still frame shots from a few seconds into each video, for display on the RPRS home and index pages. FlashVideo writes back to the database the locations of the new video and thumbnail files, so they may be incorporated in the Drupal page views.

The FLV videos stored on the Web server file system (hosting server), are available to be served to public users for a brief interval, typically less than five minutes, before a permanent video cache file can be created on the highly economical S3 server, such as the Amazon S3 service. The permanent video cache file is synchronized to a highly economical S3 server, such as the Amazon S3 by a combination of freely available Unix shell and Ruby application scripts. This synchronization allows the overhead of video download serving to be borne by the S3, an eminently scalable and reliable Web service, keeping the overhead costs associated with the Drupal/MySQL primary Web server (hosting server), comparatively low.

To display a video, a query is sent to the Drupal/MySQL server (hosting server) to obtain a video, the CCK module points to the correct video on the S3 server, where the bandwidth-display cost is less than on the hosting server, and the video appears.

To post a video, the video is sent to the Drupal/MySQL hosting server, and remains on this server for a limited amount of time, and then is sent to the S3 server. If the video is called up while on the Drupal/MySQL or hosting server, the software checks the S3 server first, to save bandwidth cost, and then checks the Drupal/MySQL or hosting server for the video. This intelligent search and retrieval process is another unique feature of the present system.

The concept and implementation of reducing the costs of server hosting and/or processing, video storage, or video bandwidth is likely to advance as technology and open source software evolves.

### DETAILED DESCRIPTION OF THE DRAWINGS

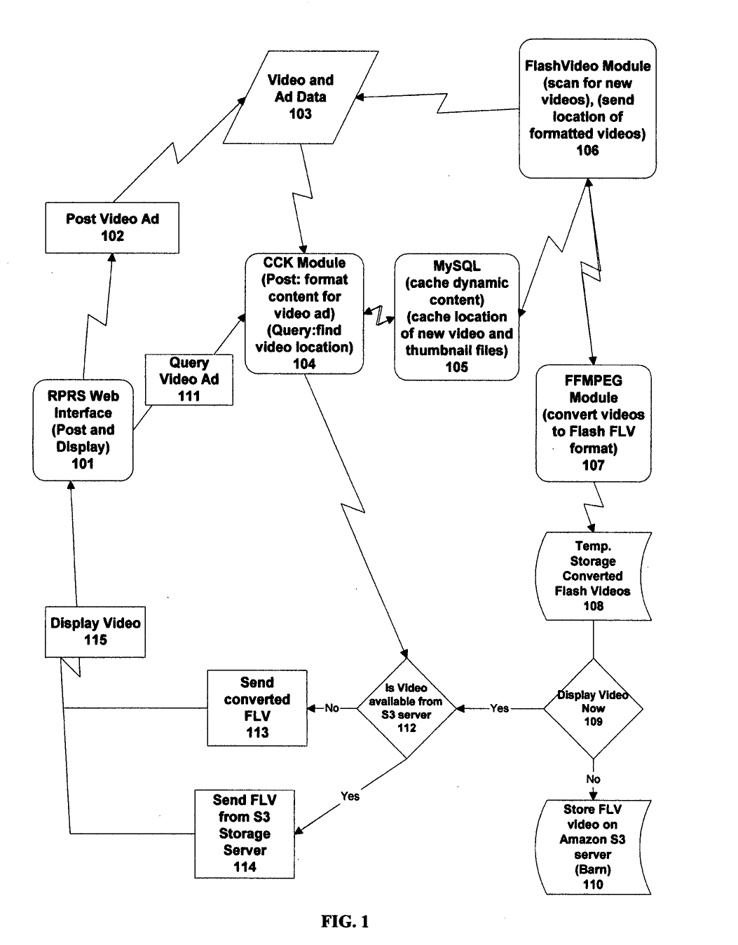

FIG. 1 is a schematic diagram of the design flow of the RPRS system, the design flow of a post or display query of a video, and the unique design that stores and uploads the resource intensive videos on a separate storage server, minimizing video bandwidth cost. When a user connects to www.realpeoplerealstuff.com, RPRS homepage, (101) he/she typically will post an ad or display an ad. When the request is a post (102), the video and ad data is stored on the web server file system (103). A module such as Drupal's CCK (104) formats the text and any references to the video media, which were provided in the RPRS Web Interface (101) and caches the formatted dynamic content in MySQL (105). The video files may be uploaded (103) to the web server in MPEG, QuickTime, AVI and Flash. A module such as Drupal's FlashVideo (106) scans the web server for any newly uploaded videos. When the process (106) finds a new video or videos, it submits the video to a module such as Drupal's FFMPEG (107) to convert the video to flash format (FLV) or maintain native video format if not convertible to flash format (FLV) and stores (108) them in a preconfigured location in the file system. A module such as Drupal's FFMPEG (107) generates and stores thumbnail-size still frame shots from a few seconds into each video for display on the RPRS homepage (101). A module such as Drupal's FlashVideo (106) writes back to the MySQL database (105) the locations of the new video and thumbnail files to be incorporated in the page views. The stored converted flash videos (108) are available to be served to public users for a brief interval (109), (less than 5 minutes) before a permanent video cache file is created (110) on a highly economical S3 server, such as the Amazon S3 service. Before any video is sent for display, the RPRS software determines (112) if the video is available on the S3 server (to reduce the cost of bandwidth to display the video). If the video is available from the S3 server then send (114) from there reducing bandwidth cost, otherwise send (113) from the temporarily stored flash video from the web server which is a higher bandwidth cost. Next the video is displayed (115) on the user's computer via the RPRS website (101). When a user requests a video from the RPRS website (101), a query (111) for the video is sent to a module such as Drupal's CCK (104) to find the video location. The RPRS software determines (112) if the video is on the S3 server. If so then the flash video (114) is sent from the S3 server reducing bandwidth cost, otherwise the temporarily stored flash video from the web server (113) is sent which results in a higher bandwidth cost. Next the video (115) is displayed on the user's computer via the RPRS website (101).

FIG. 2 is a screen shot of the RealPeopleRealStuff homepage. This page displays the most recent ads added to the site. Each ad is represented with a graphic, text and flash video. If there are many pages of videos, the result page section will show the number of pages to be viewed. From this page a user can select a video to display, post a video, search by keyword for a video, search for a video by location or category, suggest a category, login and manage his/her ads, contact RPRS, get help and view the terms of service, privacy policy and frequently asked questions.

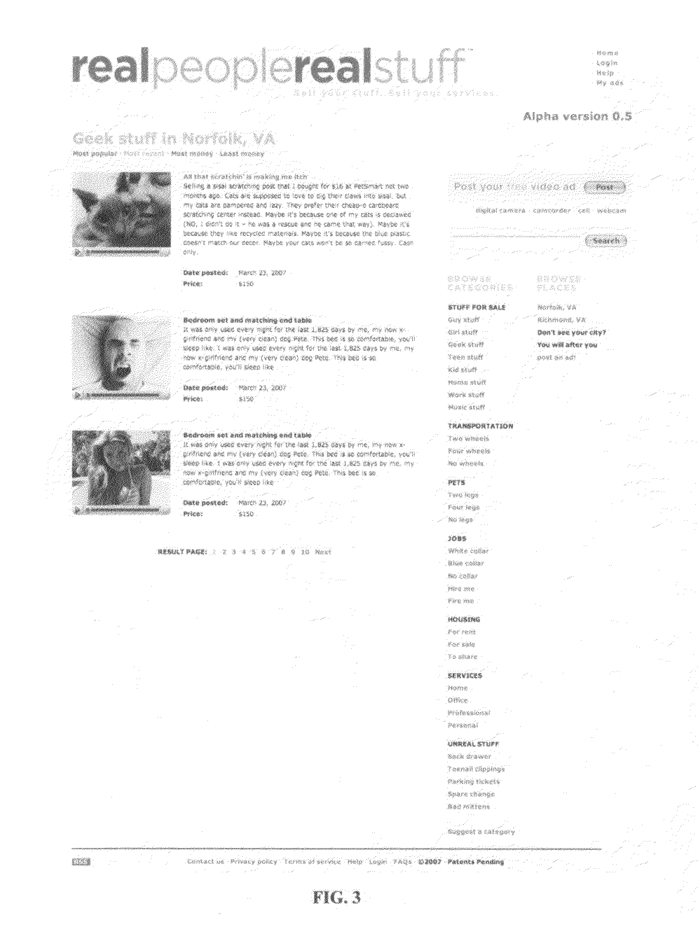

FIG. 3 is a RealPeopleRealStuff web page screen shot of a video ad search by category or place. This page displays video ads by the category or place requested by the user, with the date the video was posted and the price of the item or service. If there are many pages of videos the result page section will show the number of pages to be viewed. From this page a user can select a video to display, post a video, perform another keyword search, or search by category for a video or search for a video by location, suggest a category, login and manage his/her ads, contact RPRS, get help and view the terms of service, privacy policy and frequently asked questions.

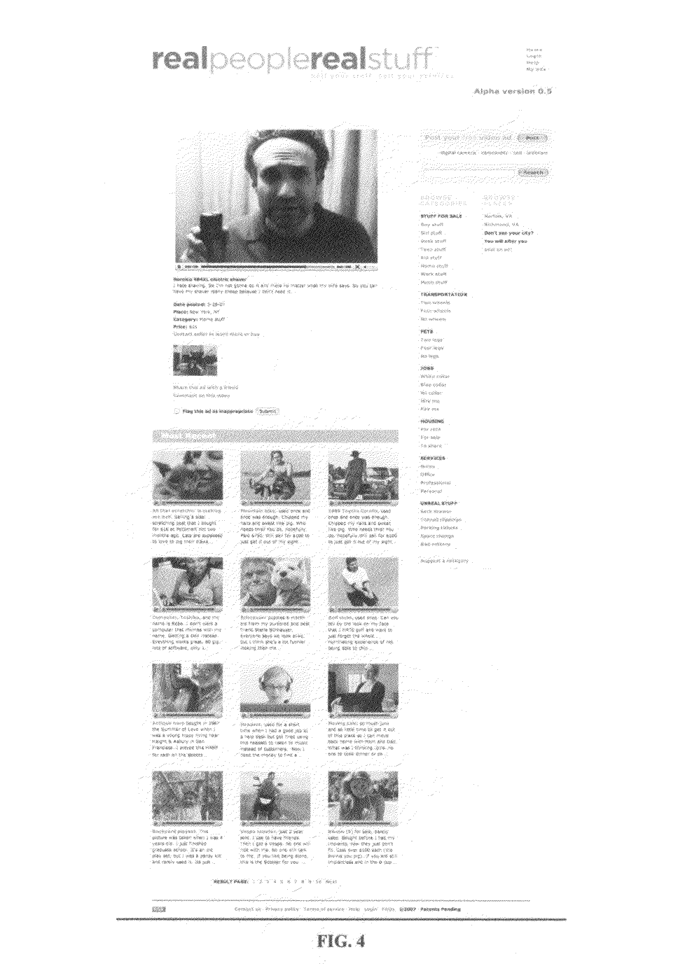

FIG. 4 is a screen shot of the RealPeopleRealStuff Play web page. This page plays the user's selected video ad. A user may flag a video ad as inappropriate and submit it to the RPRS system. In addition, this web page displays the most recent ads. If there are many pages of videos the result page section will show the number of pages to be viewed. From this page a user can select another video to display, post a video, search by keyword for a video, search for a video by location or category, suggest a category, login and manage his/her ads, contact RPRS, get help and view the terms of service, privacy policy and frequently asked questions.

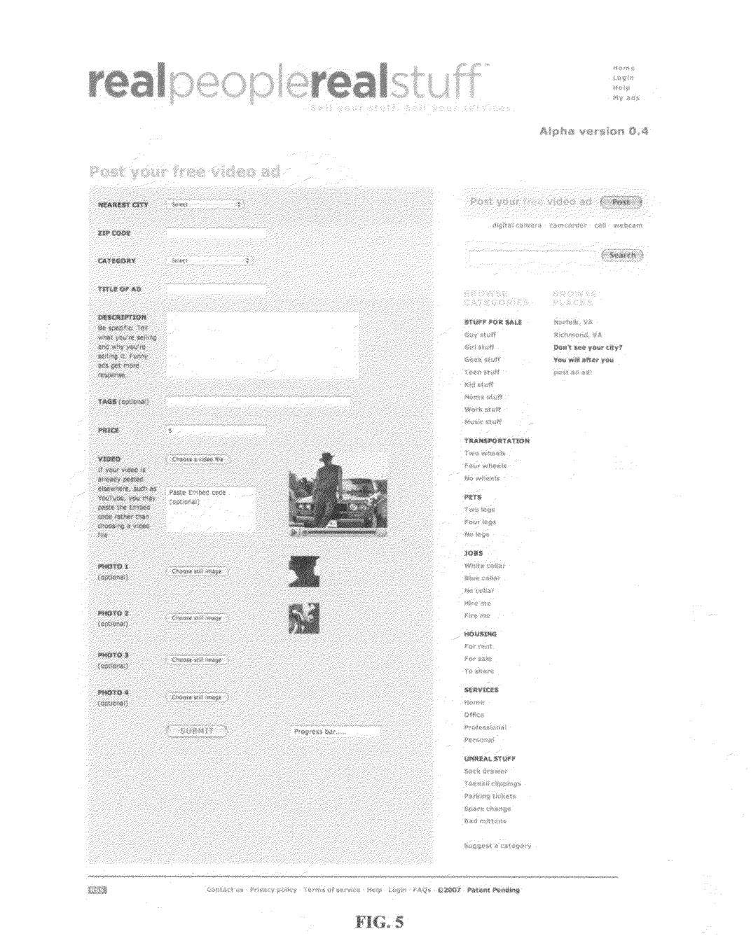

FIG. 5 is a screen capture of the RealPeopleRealStuff Post web page. From this page a user inputs the nearest city, zip code, category, title of ad, ad description, optional tags, price of item or service, video in MPEG, AVI, QuickTime or Flash formats, and optional photos for his/her video ad, then submits this data to the RPRS system

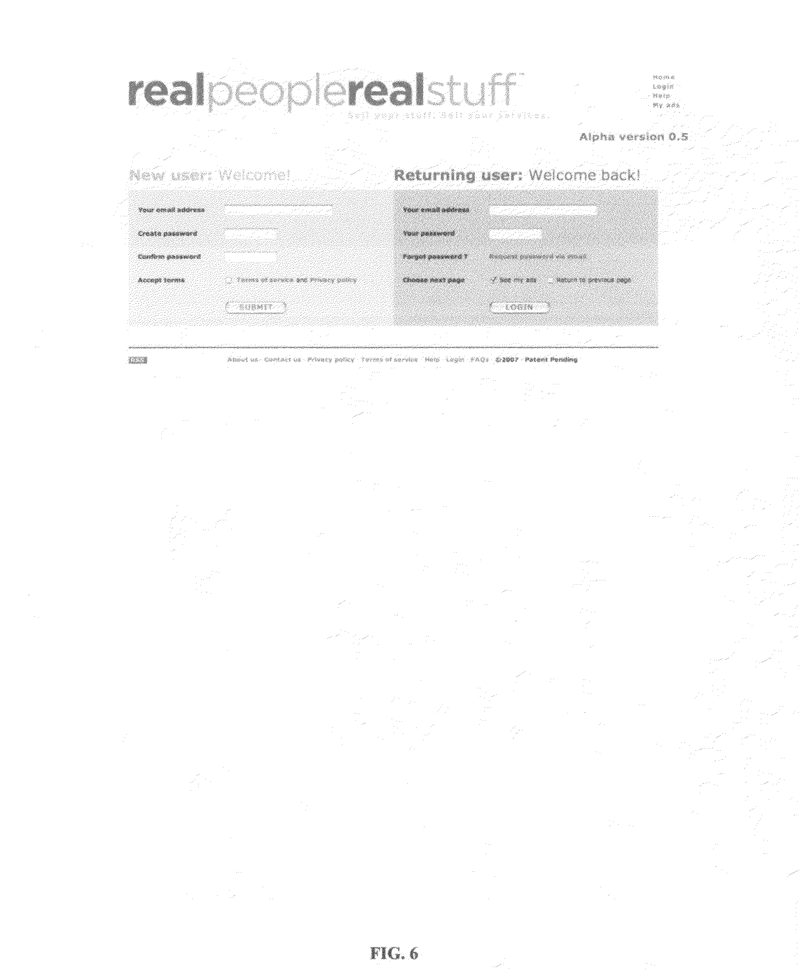

FIG. 6 is a screen shot of the RealPeopleRealStuff Login web page. This page creates a user login for a first time user. The user provides his/her email address and password and submits it to the RPRS system, whereby he/she is logged into the Manage Your Ads web page. If the user is not a first time user then he/she logins in with his/her email address and password, whereby he/she is logged into the Manage Your Ads web page. In Manage Your Ads web page, a user will be able to track their ads, schedule the frequency of the ads and pay for their ads. From this page a user can get help, view the terms of service, privacy policy, frequently asked questions and learn about RPRS.

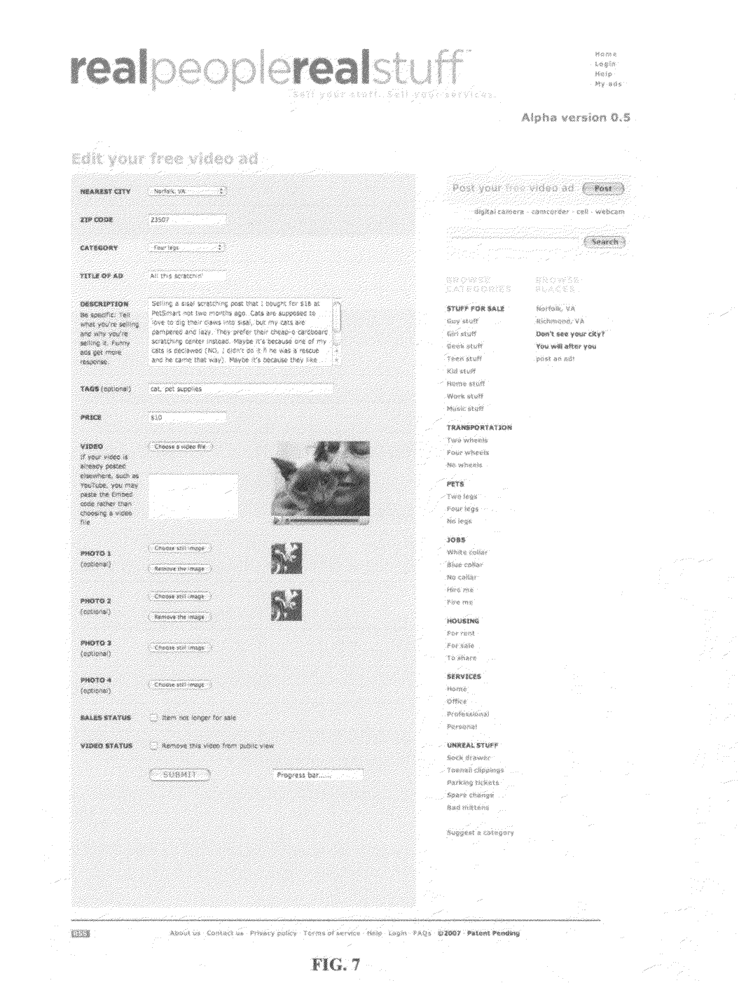

FIG. 7 is a screen shot of the RealPeopleRealStuff Edit web page. A user can edit the data fields by updating the nearest city, zip code, category, title of ad, description, tags (optional), price, video, and adding photos (optional). In addition, the user can mark the item no longer for sale and/or mark to remove the video from public view.

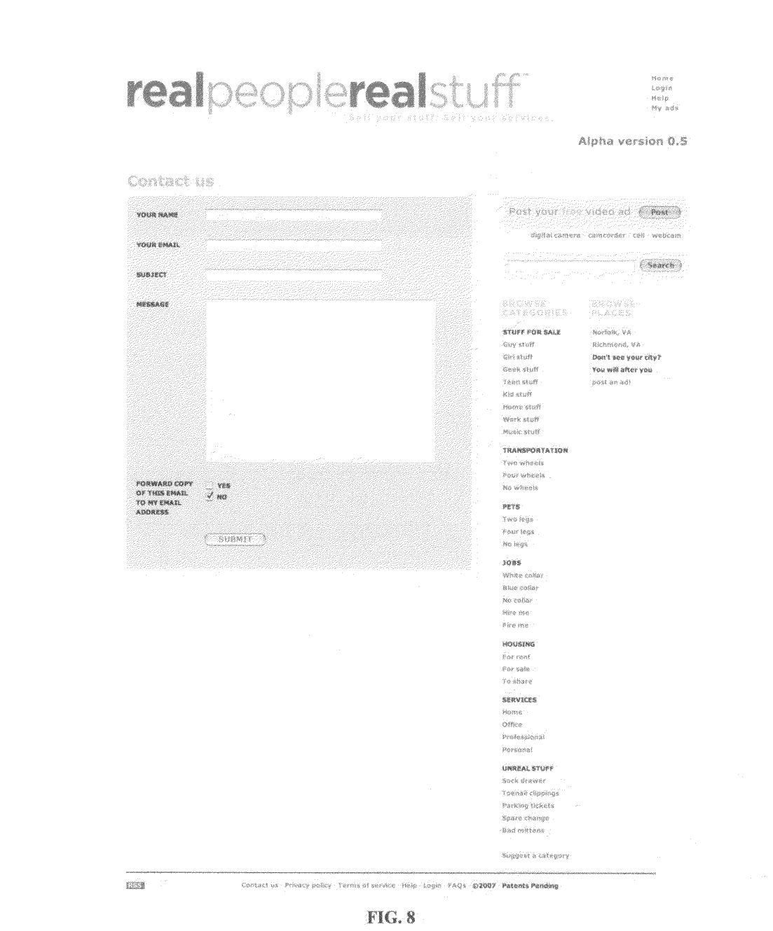

FIG. 8 is a screenshot of the RealPeopleRealStuff Contact Us web page. A user may contact RPRS by submitting his/her name, email address, subject area, and message. This message may be marked to forward to the user as well.

What is claimed is:

1. A visual or audio-visual programming system comprising;
integrating modules from open source software utilizing Drupal modules as well as PHP programming libraries, said modules including MySQL, CCK, Taxonomy, VideoFlash, FFMPEG and highly economical Simple Storage Servers (S3) such as Amazon S3 servers and combining said modules and S3 servers, thereby creating a content data model for video advertisements, with said CCK or appropriate module, converting video formats, including but not limited to MPEG, QuickTime, and AVI, into flash (FLV) format with said FFMPEG or other appropriate module, wherein if a video is not convertible, maintaining the native video format occurs while providing a software routine determining the most cost effective way to download videos, moving video storage from hosting servers, wherein said hosting servers host all processing and temporary video displays for said videos together with storage of said videos on said S3 servers, creating a Unix shell and Ruby/Perl Application Programming Interface (API) between said hosting and S3 servers, and simultaneously or later creating a category taxonomy for grouping videos, wherein said videos are provided within classified advertisement websites.

2. The programming system of claim 1, wherein a query is implemented that queries whether or not said videos are stored on Simple Storage Servers (S3), thereby allowing for considerable reduction in bandwidth and memory resources during use of said system.

3. The programming system of claim 1, wherein a posting is implemented that formats video advertisement content, and converts said video to FLV format, temporarily storing said FLV video on said hosting server for minimal display when using said hosting server, and storing said FLV format on said Simple Storage Servers (S3), thereby reducing said bandwidth display cost.

4. The programming system of claim 1, comprising at least two servers, wherein at least one server is a data processing server for storing processing and formatting of video content and allowing for processing to find video content on said data processing server and at least one server for data warehousing allowing for reducing bandwidth uploading costs as well as minimizing time for display of said video advertisement content.

5. The programming system of claim 1, wherein the visual or audio-visual programming environment utilizes any graphical user interface based operating system including but not limited to Microsoft Windows, Linux, Sun Solaris and Mac OS which support Java Virtual Machine, and wherein said system is accessible and executable with any web browser.

6. The visual or audio-visual programming environment of claim 5, wherein computationally intensive tasks initiated from a user/seller computer may also optionally be sent to said hosting and Simple Storage Servers.

7. The programming system of claim 1, allowing users to schedule frequency, track the effectiveness of their campaign(s), and pay for their advertisements without the assistance of a sales representative.

8. The programming system of claim 1, allowing users to performing all functions online, 24 hours per day, 7 days per week.

9. The programming system of claim 1, wherein the user interface is consistently and clearly designed for each web page providing distinct and unique categories or sectors for advertisement videos.

10. The programming system of claim 1, wherein said system provides a revenue model based on selling video advertisements for specific video advertisement categories or sectors and provides a method for users to generate revenue from selling their products or services via same said video advertisements.
